(19) United States
(12) Patent Application Publication
(10) Pub. No.: US 2026/0339856 A1
(43) Pub. Date: Oct. 29, 2026

(54) TRANSACTION LAYER PROTOCOL FOR COMMUNICATING HBM TRAFFIC OVER DIE-TO-DIE PHYSICAL LAYER INTERFACES

(71) Applicant: Micron Technology, Inc., Boise, ID (US)

(72) Inventors: Kunal Khochare, Folsom, CA (US); Shailesh Kayambady Sathyanarayana Bhat, Folsom, CA (US); Lakshmi Sri Sai Sudheshna Pindiprolu, Folsom, CA (US); Raymond Chang, Sacramento, CA (US); Raghukiran Sreeramaneni, Frisco, TX (US); Nevil N. Gajera, Meridian, ID (US); Ram Prasad Koganti, Wylie, TX (US)

(21) Appl. No.: 19/639,147

(22) Filed: Apr. 4, 2026

Related U.S. Application Data
(60) Provisional application No. 63/795,197, filed on Apr. 25, 2025.

(51) Int. Cl. G06F 13/18; G06F 13/16; G06F 13/38

(52) U.S. Cl. CPC G06F 13/18; G06F 13/1678; G06F 13/382

(57) ABSTRACT

A transaction layer protocol for communicating HBM traffic over die-to-die physical layer interfaces (and associated systems, devices, and methods) is disclosed herein. In one embodiment, a memory system includes a processing unit, a high bandwidth memory (HBM) device including a base die, and a die-to-die interface communicatively coupling the processing unit and the base die. The processing unit and the base die each include a HBM access protocol (HAP) adapter configured to implement an HBM access protocol for communicating HBM traffic over the die-to-die interface. The HBM access protocol can define packet structures optimized for HBM traffic and methods for packing and unpacking HBM traffic within die-to-die interface packets. The die-to-die interface can be a Universal Chiplet Interconnect Express (UCIe) interface.

### CROSS-REFERENCE TO RELATED APPLICATIONS

The present application claims priority to U.S. Provisional Patent Application No. 63/795,197, filed Apr. 25, 2025, the disclosure of which is incorporated herein by reference in its entirety.

### TECHNICAL FIELD

The present disclosure relates generally to memory systems. For example, several embodiments described in greater detail below relate to a transaction layer protocol (also referred to herein as a "high bandwidth memory (HBM) access protocol" or as a "HAP") for communicating HBM traffic over die-to-die physical layer interfaces, such as Universal Chiplet Interconnect Express (UCIe) physical layer interfaces.

### BACKGROUND

High bandwidth memory devices have become increasingly important in modern computing architectures, particularly for applications requiring high data transfer rates and low latency. An HBM device typically includes a plurality of memory dies stacked over a base die or logic die. The base or logic die is often used to communicatively couple the plurality of memory dies to a host device (e.g., a processing unit), such as via an interposer.

As computing demands continue to grow, there is an ongoing need to improve the efficiency and performance of data transfer between HBM devices and processing units communicatively coupled thereto. Die-to-die communication interfaces play a crucial role in this regard. These interfaces often utilize protocols to manage the flow of information and ensure data integrity. Existing protocols, however, may not fully address the specific requirements of HBM traffic, potentially leading to suboptimal communication bandwidths and/or efficiencies.

### BRIEF DESCRIPTION OF FIGURES

Many aspects of the present disclosure can be better understood with reference to the following drawings. The components in the drawings are not necessarily to scale. Instead, emphasis is placed on illustrating clearly the principles of the present disclosure. The drawings should not be taken to limit the disclosure to the specific embodiments shown, but are provided for explanation and understanding.

FIG. 1 is a block diagram of a memory system that implements Universal Chiplet Interconnect Express (UCIe) physical layer interfaces.

FIG. 2 is a block diagram illustrating an example UCIe-compatible packet format.

FIG. 3 is a block diagram of a memory system configured in accordance with various embodiments of the present technology.

FIG. 4 is a block diagram illustrating example read/write efficiencies and bandwidths for ideal read/write traffic with burst sizes of 64 bytes on the memory system of FIG. 3.

FIG. 5 is a graph of example read efficiencies and bandwidths for different burst sizes utilizing an HBM access protocol configured in accordance with various embodiments of the present technology.

FIG. 6 is a graph of example write efficiencies and bandwidths for different burst sizes utilizing an HBM access protocol configured in accordance with various embodiments of the present technology.

### DETAILED DESCRIPTION

The present technology relates to a transaction layer protocol (also referred to herein as a "high bandwidth memory (HBM) access protocol" or as a "HAP") for efficiently communicating HBM traffic (e.g., HBM data, commands, etc.) over die-to-die physical layer interfaces, such as Universal Chiplet Interconnect Express (UCIe) physical layer interfaces. The protocol can be implemented using HBM access protocol (HAP) adapters on both a processing unit and a base die of an HBM device. The HAP adapters can handle protocol translation between the UCIe physical layer and other components of a memory system. Several features of the HBM access protocol can include optimized packet structures, efficient packing/unpacking methods, credit-based flow control, data masking, auto-precharge functionality, variable burst size support, and quality of service prioritization. By implementing this tailored protocol, the technology aims to significantly improve bandwidth utilization and efficiency when transferring HBM traffic in comparison to other existing UCIe-supported protocols that are not specifically designed to handle HBM traffic.

In the following description, specific details are set forth to provide a thorough understanding of aspects of the present technology. One skilled in the relevant art will recognize, however, that the systems, devices, and techniques described herein can be practiced without one or more of the specific details set forth herein, or with other methods, components, materials, etc.

Reference throughout this specification to an “example” or an “embodiment” means that a particular feature, structure, or characteristic described in connection with the example or embodiment is included in at least one example or embodiment of the present technology. Thus, use of the phrases “for example,” “as an example,” or “an embodiment” herein are not necessarily all referring to the same example or embodiment and are not necessarily limited to the specific example or embodiment discussed. Furthermore, features, structures, or characteristics of the present technology described herein may be combined in any suitable manner to provide further examples or embodiments of the present technology.

Spatially relative terms (e.g., “beneath,” “below,” “over,” “under,” “above,” “upper,” “top,” “bottom,” “left,” “right,” “center,” “middle,” and the like) may be used herein for ease of description to describe one element’s or feature’s relationship relative to one or more other elements or features as illustrated in the figures. It will be understood that the spatially relative terms are intended to encompass different orientations of a device or system in use or operation, in addition to the orientation depicted in the figures. For example, if a device or system illustrated in the figures is rotated, turned, or flipped about a horizontal axis, elements or features described as “below” or “beneath” or “under” one or more other elements or features may then be oriented “above” the one or more other elements or features. Thus, the exemplary terms “below” and “under” are non-limiting and can encompass both an orientation of above and below. The device or system may additionally, or alternatively, be otherwise oriented (e.g., rotated ninety degrees about a vertical axis, or at other orientations) than illustrated in the figures, and the spatially relative descriptors used herein are interpreted accordingly. In addition, it will also be understood that when an element is referred to as being “between” two other elements, it can be the only element between the two other elements, or one or more intervening elements may also be present.

### A. Overview

High bandwidth memory (HBM) devices have become increasingly important in modern computing architectures, particularly for applications requiring high data transfer rates and low latency. These devices each typically include a plurality of memory dies arranged in one or more stacks over a base die or logic die. The base or logic die can be communicatively coupled to one or more processing units, such as via an interposer. In some cases, HBM devices and processing units may be packaged together, thereby forming a system in package (SiP) or other memory system.

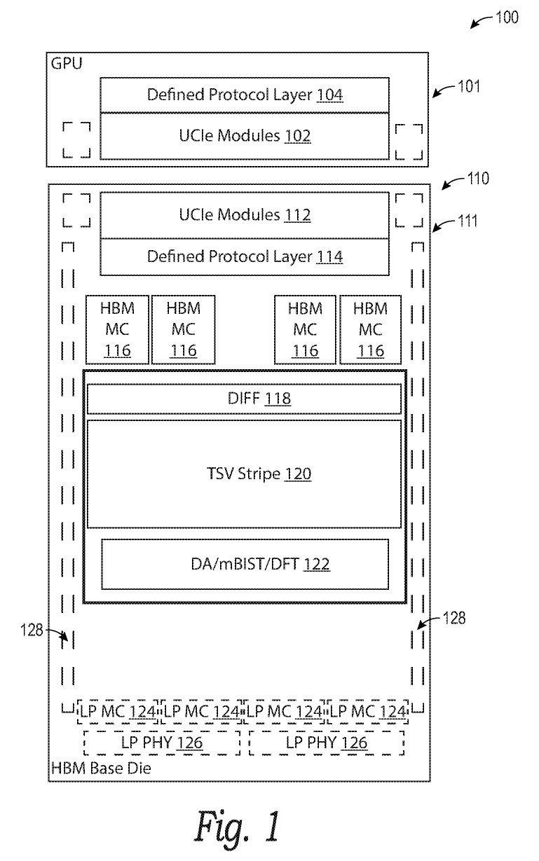

Many memory systems utilize Universal Chiplet Interconnect Express (UCIe) physical layer interfaces to facilitate communication between a processing unit and memory dies of an HBM device. For example, FIG. 1 is a block diagram of a memory system 100 (e.g., a SiP) that includes a processing unit 101 (here, a graphics processing unit (GPU)) and an HBM device 110. As shown, the HBM device 110 includes a base die 111. Implemented within the base die 111 are a plurality of HBM memory controllers 116, a double data rate (DDR) physical layer interface 118 ("DIFF 118"), a TSV stripe 120, direct access (DA)/memory built-in self-test (mBIST)/design-for-test (DFT) modules 122, low-power memory controllers 124, low-power physical layer interfaces 126, and routing channels 128. The HBM device 110 is communicatively coupled to the processing unit 101 via respective UCIe modules 112 and 102 (also referred to herein as "UCIe physical layer interfaces" or as "UCIe PHYs").

In FIG. 1, a protocol layer 104 is used within the processing unit 101 for communicating HBM traffic over the UCIe modules 102. Similarly, a protocol layer 114 is used within the base die 111 for communicating HBM traffic over the UCIe modules 112, such as between the UCIe modules 112 and the HBM memory controllers 116. The protocol layer 104 and/or the protocol layer 114 can each utilize a standard UCIe-supported protocol, such as a peripheral component interconnect (PCI) protocol, a peripheral component interconnect express (PCIe) protocol, a compute express link (CXL) protocol, a streaming protocol, a coherent hub interface (CHI) chip-to-chip (C2C) protocol, or another standard protocol that is commonly used for sending traffic over a UCIe PHY.

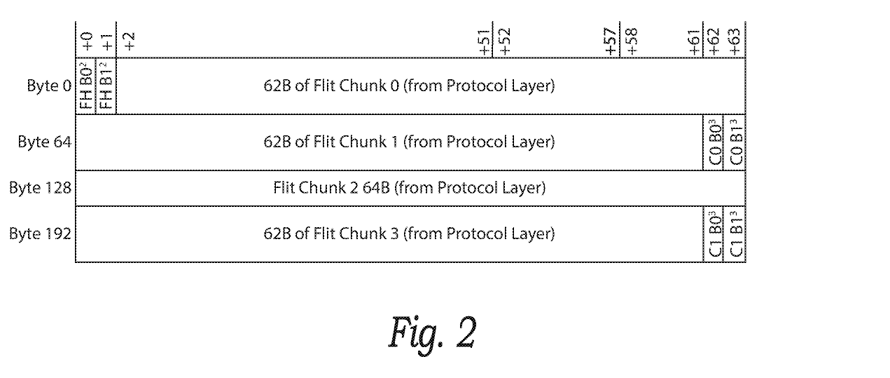

UCIe PHYs transfer data through standardized packets called "flow control units" or "flits." The UCIe spec defines several flit formats. FIG. 2 illustrates an example flit format that is known as format 6 (latency-optimized 256B with optional bytes flit format for streaming protocol). As shown, four flit chunks (three being 62 bytes in length and one being 64bytes in length) are received from a protocol layer and transmitted over a UCIe PHY, along with (a) headers (shown as Byte 0 and Byte 1 in FIG. 2) that contain protocol information and flit format identifiers, and (b) cyclic redundancy check (CRC) bytes (shown trailing Flit Chunk 1 and Flit Chunk 3 in FIG. 2) for signal/data integrity.

None of the flit formats defined in the UCIe spec, however, are specifically optimized for HBM traffic, leading to read/write inefficiencies and sub-optimal read/write bandwidths when attempting to transfer HBM traffic over UCIe PHYs using standard UCIe-supported protocols. For example, CXL-compatible and PCIe-compatible flit formats have low efficiency when used for transferring HBM traffic and do not meet necessary bandwidth requirements. In addition, none of the standard protocols define or specify how to pack HBM traffic into a UCIe flit, often leading to suboptimal use of available bandwidth. Furthermore, many of these standard protocols lack standardized flow control mechanisms and support for features like partial writes or auto-precharge, which are beneficial for HBM operations. The inefficiencies of existing protocols can therefore result in reduced bandwidth utilization and increased latency in memory systems employing HBM devices that are communicatively coupled to processing units (or other host devices) via a UCIe PHY.

To address the inefficiencies and limitations of existing protocols for transferring HBM traffic over UCIe PHYs, memory systems configured in accordance with the present technology employ a transaction layer protocol (also referred to herein as a "HBM access protocol" or as a "HAP") that is specifically designed for efficient communication of HBM traffic over die-to-die (D2D) physical layer interfaces (e.g., between processing units and HBM devices). In some embodiments, the HBM access protocol is implemented using (a) a HAP adapter positioned between HBM memory controllers and a D2D adapter/UCIe PHY on a base die of an HBM device and/or (b) a HAP adapter positioned on a processing unit and coupled to a D2D adapter/UCIe PHY of the processing unit.

The HAP can include one or more features that address the shortcomings of existing UCIe-supported protocols. For example, the HAP can define specific packet structures for read commands, write commands, and data packets that are optimized for HBM traffic. The HAP may also specify methods for efficiently packing and unpacking HBM traffic within UCIe flits, ensuring optimal utilization of available bandwidth. Additionally, the HAP can implement a credit mechanism for flow control to prevent buffer overflow and manage data transfer rates between a processing unit and an HBM device. Other features of the HAP may include support for data masks to enable partial writes and read-modify-write operations, auto-precharge functionality, support for variable burst sizes, quality of service (QoS) prioritization, and/or error reporting capabilities. Implementation of the HAP is therefore expected to significantly improve bandwidth utilization and efficiency in comparison to existing UCIe-supported protocols.

### B. Selected Embodiments of the Present Technology

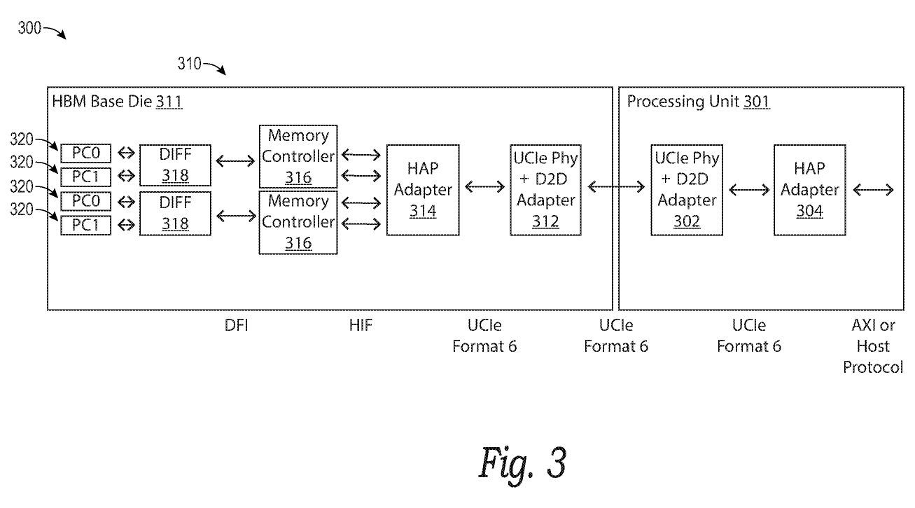

FIG. 3 illustrates a block diagram of a memory system 300 configured in accordance with various embodiments of the present technology. As shown, the memory system 300 includes a processing unit 301 (also referred to herein as a "compute die" or as a "host device") and a high bandwidth memory (HBM) device 310. The processing unit 301 can be a central processing unit (CPU), a graphics processing unit (GPU), an associative processing unit (APU), a tensor processing unit (TPU), or another suitable type of compute die.

The HBM device 310 includes a base die 311 (also referred to as an "interface die" or a "logic die"). The base die 311 can include various modules and/or components, such as HBM memory controllers 316, DDR PHYs 318 ("DIFFs 318"), and/or pseudo channels 320. Each of the pseudo channels 320 can be communicatively to a corresponding DIFF 318. In addition, each of the DIFFs 318 can be communicatively coupled to a corresponding HBM memory controller 316. In some embodiments, the DIFFs 318 and the HBM memory controllers 316 can communicate using a DDR PHY interface (DFI) protocol.

The processing unit 301 and the base die 311 of the HBM device 310 can be communicatively coupled to one another via a die-to-die (D2D) interface. For the sake of example, the D2D interface is illustrated as a UCIe D2D interface but can be a different type of D2D interface in other embodiments. As shown, the processing unit 301 can include a UCIe PHY 302 (and an associated D2D adapter), and the base die 311 can include a UCIe PHY 312 (and an associated D2D adapter) that is configured to send/receive HBM traffic to/from the UCIe PHY 302. In some embodiments, a UCIe streaming format 6 link layer protocol can be used to transfer HBM traffic over and/or between the UCIe PHYs 302 and 312 (and their associated D2D adapters).

In the illustrated embodiment, the processing unit 301 further includes a HAP adapter 304, and the base die 311 further includes a HAP adapter 314. The HAP adapter 314 in the base die 311 may handle protocol translation between the UCIe physical layer and the HBM memory controllers 316. As a specific example, the HAP adapter 314 may handle protocol translation between (a) a UCIe streaming format 6 link layer protocol that is used for communications between the HAP adapter 314 and the UCIe PHY 312, and (b) a host interface protocol (HIF) that is used for communications between the HAP adapter 314 and the memory controllers 316. The HAP adapter 314 may be configured to handle protocol translation and/or process memory access requests using an HBM access protocol (HAP) that is described in greater detail below.

Similarly, the HAP adapter 304 in the processing unit 301 may handle protocol translation between the UCIe physical layer and other components (not shown) of the processing unit 301 and/or a connected host device (not shown). As a specific example, the HAP adapter 304 may handle protocol translation between (a) a UCIe streaming format 6 link layer protocol that is used for communications between the HAP adapter 304 and the UCIe PHY 302, and (b) an advanced extensible interface (AXI) protocol or a host protocol that is used for communications between the HAP adapter 304 and the other components of the processing unit 301 and/or a connected host device. The HAP adapter 304 may be configured to handle protocol translation and/or process memory access requests using the HBM access protocol (HAP).

The HBM access protocol can be specifically designed to communicate HBM traffic over the die-to-die interface. To this end, the HBM access protocol implemented by the HAP adapters 304 and 314 may include several features designed to optimize read/write efficiencies and/or bandwidths over the die-to-die interface. As a first example, the HBM access protocol may provide packet definitions, such as specific packet structures for read commands, write commands, and/or data packets, that are optimized or tailored for HBM traffic. These packet formats/structures may include fields for address information, transaction identifiers, burst length, and other HBM-specific parameters. The packet formats/structures may be designed to minimize overhead/maximize bandwidth utilization while providing all necessary information for efficient memory access. For example, these formats may be designed to align with HBM data bus widths and burst lengths, potentially allowing for more efficient data transfer compared to generic protocols.

As a second example, the HBM access protocol may specify methods for packing HBM traffic into UCIe flits and/or for unpacking HBM traffic from UCIe flits. In this manner, the HBM access protocol can ensure packing and unpacking consistency across the processing unit 301 and the HBM device 310. The packing and/or unpacking methods defined by the HBM access protocol may be specifically designed to efficiently pack/unpack HBM traffic into UCIe flits, thereby improving read/write efficiencies and bandwidths.

As a third example, the HBM access protocol may implement a credit mechanism for flow control. In this manner, the HBM access protocol can be used to manage data transfer rates between the processing unit 301 and HBM device 310. Such a mechanism may help prevent buffer overflows and ensure smooth data transmission, potentially reducing latency and improving overall system performance and reliability.

As a fourth example, the HBM access protocol may provide data masking functionality to support partial write operations and/or read-modify-write (RMW) operations. In some embodiments, the data masking can be implemented using byte enables for write data transmitted from the processing unit 301 to the HBM device 310. The data masking feature is expected to allow for more granular memory updates, potentially reducing unnecessary data transfers (improving write bandwidth and efficiency).

As a fifth example, the HBM access protocol may enable auto-precharge functionality. More specifically, the HBM access protocol may facilitate implementing read auto-precharge commands and/or write auto-precharge commands, potentially reducing the number of explicit precharge operations and improving overall memory access efficiency. For example, as the processing unit 301 transmits a read or write command to the HBM device 310, information included in the communication can indicate whether that read/write command should be transmitted to the memory dies with or without a precharge command.

As a sixth example, the HBM access protocol may support use of variable burst sizes. As specific example, the HBM access protocol may support burst sizes of 32 bytes, 64 bytes, 128 bytes, 256 bytes, 512 bytes, and/or one or more other suitable burst sizes. Thus, the HBM access protocol may enable use of flexible (or dynamically adjusted) burst sizes, potentially enabling more efficient use of available bandwidth for different types of memory operations. In some embodiments, burst size or burst length can be indicated in a packet field defined by the HBM access protocol.

As a seventh example, the HBM access protocol may provide quality of service (QoS) prioritization features, such as mechanisms for prioritizing execution of certain commands/operations based on QoS requirements. This feature may help ensure critical operations receive necessary bandwidth and are processed in a timely manner. In some embodiments, priority information (e.g., high priority, low priority) can be indicated in a packet field defined by the HBM access protocol.

As an eighth example, the HBM access protocol may provide latency timeout features to manage and monitor the timing of memory access operations. These features may allow the system to set specific time limits for memory access requests, helping to identify and handle potential issues that could lead to excessive latency. In some implementations, the latency timeout feature may involve setting configurable timeout thresholds for different types of memory operations. For example, read requests, write requests, and other memory access commands may each have their own associated timeout values. These timeout values may be adjustable based on system requirements or specific application needs. The HBM access protocol may incorporate mechanisms to track the time elapsed since a memory access request was initiated. If a response is not received within the specified timeout period, the protocol may trigger certain actions. These actions may include adjusting the priority of the request (e.g., from low to high), retrying the request, notifying the system of a potential issue, or initiating error recovery procedures. Additionally, the latency timeout feature may work in conjunction with the quality of service (QoS) prioritization mechanisms described above. For example, higher priority requests may be assigned shorter timeout periods to ensure they are processed more quickly. This approach may help maintain overall system responsiveness and performance, especially for time-sensitive operations.

As a ninth example, the HBM access protocol may define specific methods for reporting and handling errors that may occur during data transfer. This may include mechanisms for detecting transmission errors, reporting them to the appropriate components, and potentially initiating error recovery procedures. Additionally, or alternatively, this may also include different methods for reporting and handling errors based on the type and/or severity of errors that occur (e.g., different methods for reporting and handling correctable versus uncorrectable errors).

As a tenth example, the HBM access protocol may incorporate data poisoning features to enhance error detection and handling capabilities. For example, the HBM access protocol may facilitate intentionally corrupting data to generate known bad data and/or writing the known bad data to HBM memory. This may allow for using the known bad data to test error detection and handling capabilities of the HBM device 310 and/or the processing unit 301.

Still other examples of features that can be implemented by the HBM access protocol include (a) low-latency command scheduling, (b) power-management support, (c) multi-channel support, and/or (d) optimized address mapping. Low-latency command scheduling may include mechanism and procedures for efficient command scheduling, potentially reducing latency between the issuance of a memory access request and its execution. Power management support may include power management features, such as the ability to transition between different power states or adjust data transfer rates to optimize power consumption. Multi-channel support features may enable efficiently handling of multiple HBM channels, potentially allowing for parallel memory access operations and improved overall bandwidth. Optimized address mapping features may include features for efficient address mapping between the processing unit's address space and the HBM device's internal structure, potentially improving access patterns and overall memory performance.

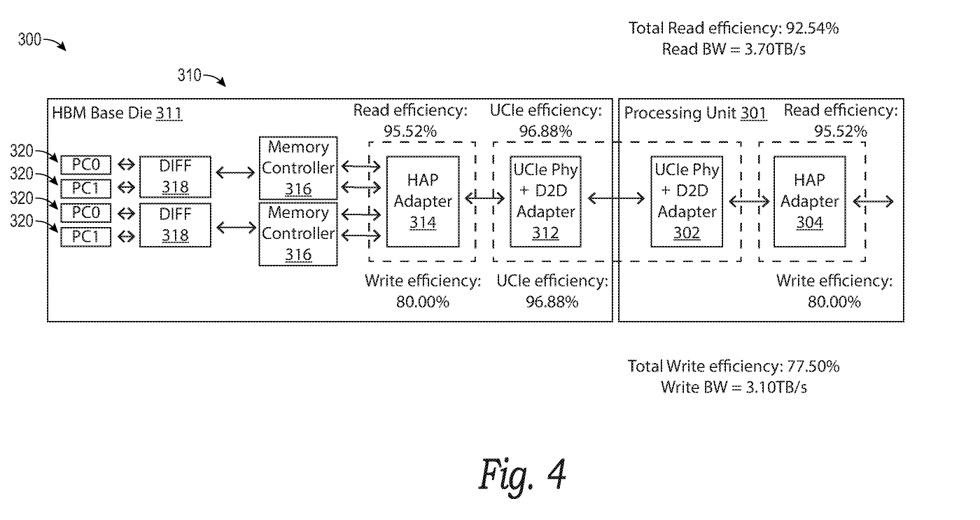

As discussed above, the HBM access protocol is expected to minimize overhead and maximize bandwidth utilization while transferring HBM traffic over the D2D interface. FIG. 4 illustrates example protocol read and write efficiency and bandwidth measurements on the memory system 300 of FIG. 3 when implementing the HBM access protocol given a burst length of 64 bytes and assuming synthetic, ideal IDD4R/IDD4W traffic. For read operations, anticipated read efficiencies over the HAP adapters 304 and 314 are each 95.52% while an anticipated read efficiency over the UCIe PHYs 302 and 312 is 96.88%. Thus, an anticipated total read efficiency is shown as 92.54% with an anticipated read bandwidth of 3.70TB/s (assuming a raw bandwidth of 4TB/s). For write operations, anticipated write efficiencies over the HAP adapters 304 and 314 are each 80.00% while the anticipated write efficiency over the UCIe PHYs 302 and 312 is 96.88%. Thus, an anticipated total write efficiency is shown as 77.50% with an anticipated write bandwidth of 3.10TB/s (assuming a raw bandwidth of 4TB/S). Therefore, it is expected that, by implementing an HBM access protocol of the present technology that is specifically tailored to handling HBM traffic over the D2D interface, each of read efficiency, write efficiency, read bandwidth, and write bandwidth will be greater than these same measurements when implementing other (existing/standard) UCIe-supported protocols.

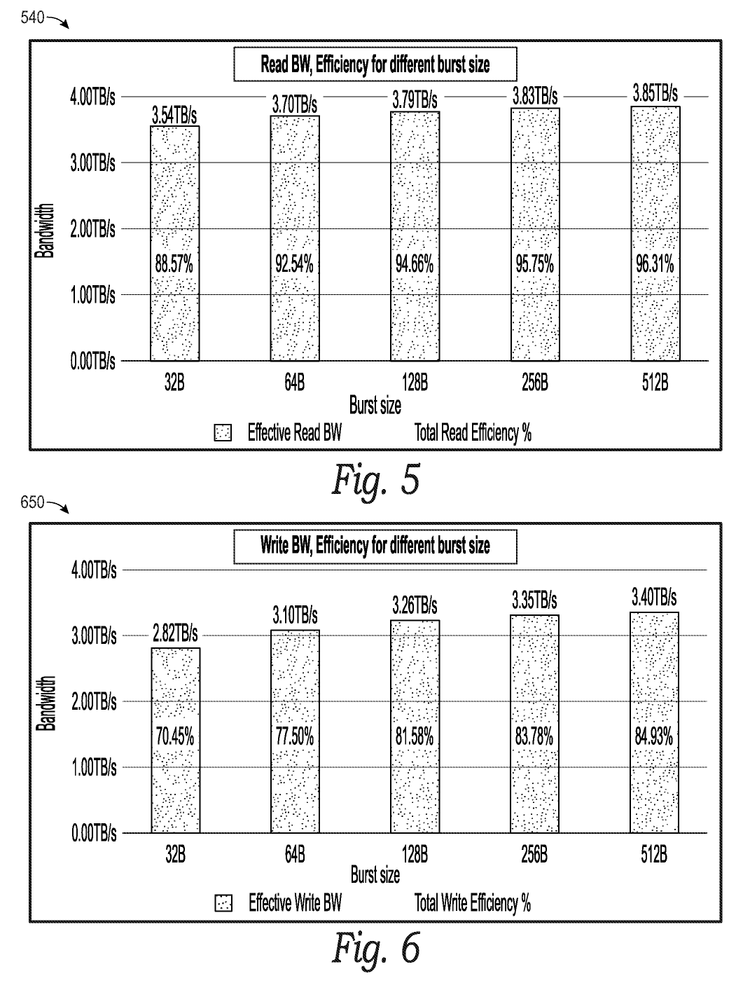

FIGS. 5 and 6 illustrate example read bandwidth and efficiency measurements and example write bandwidth and efficiency measurements, respectively, for different burst sizes when implementing an HBM access protocol of the present technology to transfer HBM traffic over a D2D interface. Referring first to FIG. 5, graph 540 depicts anticipated effective read bandwidth and total read efficiency percentages across various burst sizes ranging from 32 bytes to 512 bytes. As shown, anticipated effective read bandwidth increases from approximately 3.54 TB/s at a 32-byte burst size to approximately 3.85 TB/s at a 512-byte burst size. Correspondingly, anticipated total read efficiency percentage increases from about 88.57% at a 32-byte burst size to about 96.31% at a 512-byte burst size.

Referring now to FIG. 6, graph 650 depicts anticipated effective write bandwidth and total write efficiency percentages across the same burst sizes. As shown, the anticipated effective write bandwidth increases from approximately 2.82 TB/s at a 32-byte burst size to approximately 3.40 TB/s at a 512-byte burst size. Similarly, the anticipated total write efficiency percentage increases from about 70.45% at a 32-byte burst size to about 84.93% at a 512-byte burst size.

The trends observed in the graphs 540 and 650 indicate that both read and write operations benefit from larger burst sizes in terms of bandwidth and efficiency. This improvement may be attributed to reduced overhead associated with larger data transfers. As burst sizes increase, the ratio of actual data transferred to protocol overhead (e.g., headers, command information) may increase, leading to higher overall efficiency and bandwidth utilization.

These measurements may have implications for system performance in the memory system 300. For example, the memory system 300 may be configured to utilize larger burst sizes when possible to maximize bandwidth and efficiency and/or improve overall system performance. It may be noted, however, that the choice of burst size may depend on various factors beyond just bandwidth and efficiency. For example, smaller burst sizes may be preferred in scenarios requiring lower latency or more granular memory access. Therefore, the memory system 300 may be designed to dynamically adjust burst sizes based on specific application requirements and workload characteristics, and the HBM access protocol of the present technology may support each of the various burst sizes.

### C. Conclusion

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology as those skilled in the relevant art will recognize. For example, although steps are presented in a given order above, alternative embodiments may perform steps in a different order. Furthermore, the various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology.

Where the context permits, singular or plural terms may also include the plural or singular term, respectively. In addition, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Moreover, as used herein, the phrases “based on,” “depends on,” “as a result of,” and “in response to” shall not be construed as a reference to a closed set of conditions. For example, an exemplary step that is described as “based on condition A” may be based on both condition A and condition B without departing from the scope of the present disclosure. In other words, as used herein, the phrase “based on” shall be construed in the same manner as the phrase “based at least in part on” or the phrase “based at least partially on.”

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments. Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A memory system, comprising:
a processing unit;
a high bandwidth memory (HBM) device including a base die; and
a die-to-die interface communicatively coupling the processing unit and the base die, wherein the processing unit and the base die each include a HBM access protocol (HAP) adapter configured to implement an HBM access protocol for communicating HBM traffic over the die-to-die interface, the HBM access protocol defining packet structures optimized for HBM traffic and methods for packing and unpacking HBM traffic within die-to-die interface packets.

2. The memory system of claim 1, wherein the die-to-die interface is a Universal Chiplet Interconnect Express (UCIe) interface.

3. The memory system of claim 2, wherein the HBM device includes a first UCIe physical layer interface (PHY) of the die-to-die interface, wherein the processing unit includes a second UCIe PHY of the die-to-die interface, and wherein the first UCIe PHY is communicatively coupled to the second UCIe PHY.

4. The memory system of claim 1, wherein the HBM access protocol implements a credit mechanism for flow control to manage data transfer rates between the processing unit and the HBM device.

5. The memory system of claim 1, wherein the HBM access protocol provides data masking functionality to support partial write operations and read-modify-write operations.

6. The memory system of claim 1, wherein the HBM access protocol supports variable burst sizes.

7. The memory system of claim 6, wherein the variable burst sizes include 32 bytes, 64 bytes, 128 bytes, 256 bytes, and 512 bytes.

8. The memory system of claim 1, wherein the HBM access protocol provides quality of service (QoS) prioritization features for prioritizing execution of certain commands based on QoS requirements.

9. The memory system of claim 1, wherein the HBM access protocol provides latency timeout features to manage and monitor timing of memory access operations, the latency timeout features including configurable timeout thresholds for different types of memory operations.

10. The memory system of claim 1, wherein the HBM access protocol defines a packet field for enabling or disabling auto-precharge operations with a corresponding read or write command.

11. The memory system of claim 1, wherein the HBM access protocol defines error reporting procedures for different types of errors.

12. The memory system of claim 1, wherein the HBM access protocol provides data poisoning features for writing poisoned data in memory of the HBM device.

13. The memory system of claim 1, wherein the memory system is a system-in-package (SiP).

14. A method of communicating high bandwidth memory (HBM) traffic between a host device and an HBM device over a die-to-die interface, the method comprising:
receiving, at a HBM access protocol (HAP) adapter, a memory access request; and
processing the memory access request using an HBM access protocol to generate one or more packets, wherein the HBM access protocol defines packet structures optimized for HBM traffic.

15. The method of claim 14, wherein:
processing the memory access request using the HBM access protocol includes packing one or more die-to-die interface packets with first HBM traffic in accordance with a packing procedure defined by the HBM access protocol; and
the method further comprises transmitting the one or more die-to-die interface packets over the die-to-die interface to a HAP adapter of the HBM device.

16. The method of claim 14, wherein:
receiving the memory access request includes receiving die-to-die interface packets from the die-to-die interface; and
processing the memory access request using the HBM access protocol includes unpacking first HBM traffic from the die-to-die interface packets in accordance with an unpacking procedure defined by the HBM access protocol.

17. The method of claim 14, wherein processing the memory access request includes translating between (a) a UCIe streaming format 6 link layer protocol and (b) a host interface protocol (HIF).

18. The method of claim 14, wherein processing the memory access request includes translating between (a) a UCIe streaming format 6 link layer protocol and (b) an advanced extensible interface (AXI) protocol or a host protocol.

19. A high bandwidth memory (HBM) device, comprising:
a base die including—
one or more HBM memory controllers,
a die-to-die physical layer interface configured to communicatively couple the base die to a host device; and
an HBM access protocol (HAP) adapter communicatively coupling the one or more HBM memory controllers to the die-to-die physical layer interface, wherein the HAP adapter is configured to implement an HBM access protocol for communicating HBM traffic between the one or more HBM memory controllers and the host device over the die-to-die interface, and wherein the HBM access protocol defines packet structures optimized for HBM traffic.

20. The HBM device of claim 19, wherein the HBM access protocol further defines methods for packing and unpacking HBM traffic within die-to-die interface packets.
